(19) United States
(12) Patent Application Publication
(10) Pub. No.: US 2005/0230931 A1
(43) Pub. Date: Oct. 20, 2005

(54) Skateboard reinforcement

(76) Inventor: Ting Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/827,263

(22) Filed: Apr. 20, 2004

(51) Int. Cl. B62M 1/00

(52) U.S. Cl. 280/87.042

(57) ABSTRACT

A skateboard reinforcement includes a metal reinforcing plate secured to the bottom of a skateboard. The reinforcing plate has a pair of ribs extending at the center bottom portion and two flat surfaces at the respective ends thereof. Each flat surface has a plurality of holes thereon. The reinforcing plate is to reinforce the strength of the skateboard.

### FIELD OF THE INVENTION

This invention relates to a skateboard reinforcement, and more particularly to a skateboard with a metal reinforcing plate having ribs secured to the bottom of the skateboard to reinforce the strength of the skateboard.

### BACKGROUND OF THE INVENTION

A skateboard is one of the most popular sports to youngsters for its maneuverability. The young like to play some high technical movements with the skateboard. These movements require a stronger structure of the skateboard. In some occasions, the skateboard cannot sustain these high technical performances and either crack or falling apart.

In view of these and many other shortcomings, the inventor has derived the present invention to attach an enforcing plate to the skateboard.

### SUMMARY OF THE INVENTION

It is the primary object of the present invention to provide a skateboard reinforcement, which is stronger in structure to sustain.

### BRIEF DESCRIPTION OF THE DRAWINGS

FIG. 1 is a perspective view of the present invention; and

FIG. 2 is a side view of the present invention.

### DETAILED DESCRIPTION OF THE PREFERRED EMBODIMENT

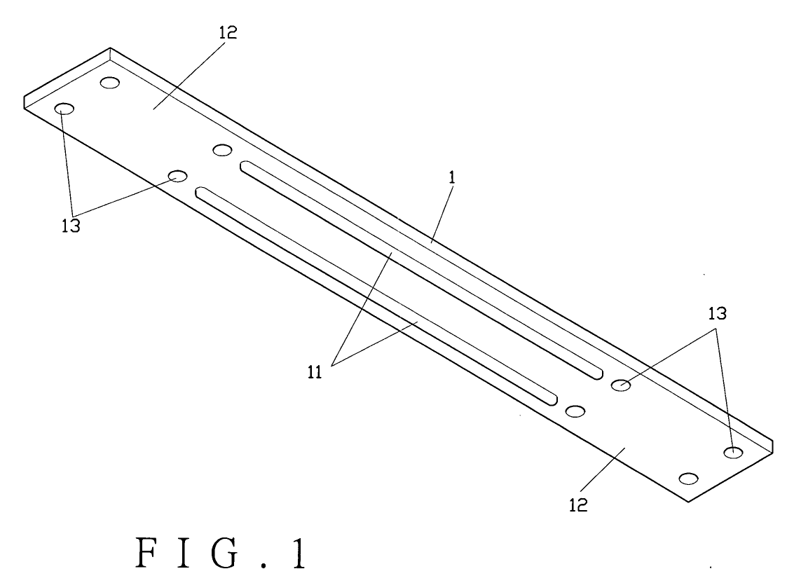

As shown in FIG. 1, the present invention comprises a metal reinforcing plate 1 which has a pair of ribs 11 extending at the center bottom portion. Two ends of the reinforcing plate 1 are formed with flat surfaces 12. Each flat surface 12 comprises a plurality of holes 13 thereon.

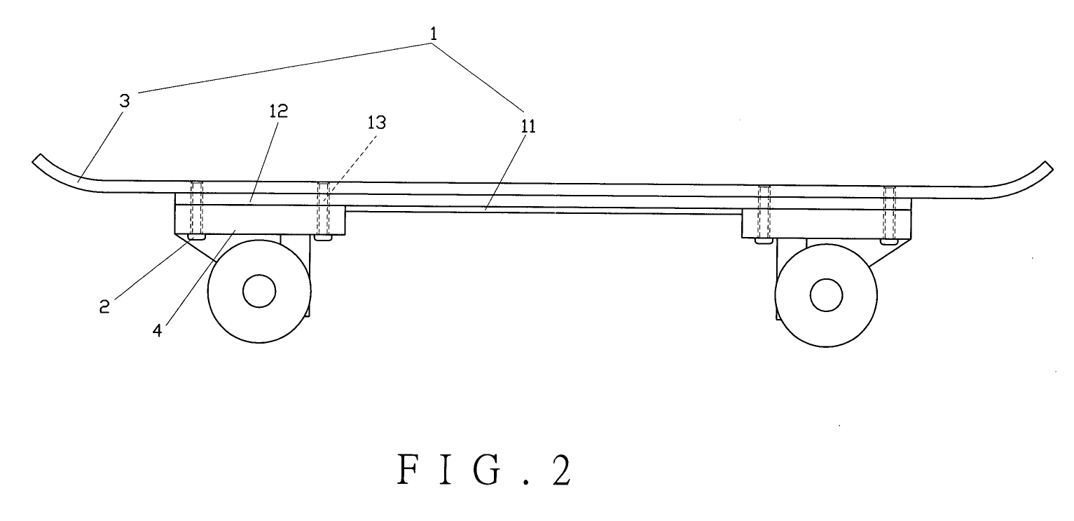

As shown in FIG. 2, the present invention is coupled with a skateboard 3, wheel bases 2 and fasteners 12. The fasteners 2 are inserted through the wheel bases 4 and the holes 13 of the reinforcing plate 1 to secure the wheel bases 4 and the reinforcing plate 1 to the bottom of the skateboard 3. The reinforcing plate 1 is to reinforce the structure of the skateboard 3.

1. A skateboard reinforcement comprising a metal reinforcing plate secured to a bottom of a skateboard by means of fasteners, and characterized in that:
said reinforcing plate comprising at least two ribs at a center bottom portion, two ends of said reinforcing plate being formed with flat surfaces, said flat surfaces each having a plurality of holes thereon.
